(19) United States
(12) Patent Application Publication
(10) Pub. No.: US 2026/0322913 A1
(43) Pub. Date: Oct. 15, 2026

(54) SYSTEM FOR DISABLING SCREEN ENGAGEMENT WHILE DRIVING

(71) Applicant: Eric Zerof, Brooklyn, NY (US)

(72) Inventor: Eric Zerof, Brooklyn, NY (US)

(21) Appl. No.: 19/643,474

(22) Filed: Apr. 9, 2026

Related U.S. Application Data
(60) Provisional application No. 63/786,797, filed on Apr. 10, 2025.

(51) Int. Cl. H04M 1/72454; G06Q 40/08; H04M 1/60; H04M 1/72409; H04M 1/72412; H04M 1/72436; H04M 1/72463

(52) U.S. Cl. CPC H04M 1/72454; G06Q 40/086; H04M 1/6075; H04M 1/724098; H04M 1/72412; H04M 1/72436; H04M 1/724634; H04M 2250/10; H04M 2250/12

(57) ABSTRACT

A system for disabling screen engagement on a mobile device is provided. The system includes a device coupled to a vehicle adjacent a steering wheel and a mobile device running a mobile application coupled to the device. The mobile device operating the mobile application is programmed to determine a speed of the vehicle while traveling. The device communicates with the mobile device through an ultrawideband signal to determine a distance between the device and the mobile device. The mobile device operating the mobile application is programmed to determine that the speed is at or above a threshold speed and that the distance is at or below a threshold distance, and to place the mobile device in a blocked mode in response to the speed being at or above the threshold speed and the distance being at or below the threshold distance. This system periodically reports usage to a remote database.

### CROSS-REFERENCE TO RELATED APPLICATIONS

This application claims priority to U.S. Application No. 63/786,797, filed Apr. 10, 2025, which is hereby incorporated by reference in its entirety.

### TECHNICAL FIELD

This invention relates to a system for disabling screen engagement while driving, and more particularly to a system that senses movement of a vehicle while a mobile device is within proximity of the driver's location within the vehicle and disabling screen engagement on the mobile device and periodically reporting usage of the system to insurance companies or other interested parties.

### STATE OF THE ART

Mobile phone use while driving is an increasing problem. Many drivers can typically be seen utilizing a phone while actively driving and this is a major problem and the cause of many vehicle accidents. Laws have been enacted in attempts to curb the utilization of phones while driving. Mobile phone manufacturers have also created modes or applications that can place the phone in a safe driving mode. Additionally, systems exist that can place a phone in a safe drive mode that prevents using phones for tasks like messaging on the phone while a vehicle is moving, however, all of these systems do so based on the speed of the vehicle. This means that all phones in a vehicle could be placed in a safe driving mode unless bypassed by the users of the mobile phones. These systems lack the ability to locate the mobile phone within a vehicle that in a location that use could only be performed by the driver of the vehicle.

Accordingly, there is a need for a system that senses movement of a vehicle while a mobile device is within proximity of the driver's location within the vehicle and disabling screen engagement on the mobile device and that provides periodic reports of system usage to insurance companies, etc.

### SUMMARY OF THE INVENTION

In one embodiment, a system for disabling screen engagement on a mobile device is provided. In this embodiment, the system includes a device coupled to a vehicle adjacent a steering wheel of the vehicle and a mobile device running a mobile application, the mobile device coupled to the device. The mobile device operating the mobile application is programmed to determine a speed of the vehicle while traveling. The device communicates with the mobile device through an ultrawideband signal and is programmed to determine a distance between the device and the mobile device. The mobile device operating the mobile application is programmed to determine that the speed of the vehicle is at or above a threshold speed and that the distance between the mobile device and the device is at or below a threshold distance. The mobile device operating the mobile application is programmed to place the mobile device in a blocked mode in response to the speed of the vehicle being at or above a threshold speed and that the distance between the mobile device and the device being at or below a threshold distance.

In another embodiment, a method for disabling screen engagement on a mobile device is provided. In this embodiment, the method includes sensing, by a mobile device operating a mobile application, movement of a vehicle at a velocity above a threshold speed. The method further includes determining, by the mobile device operating the mobile application, a proximity of the mobile device to a driver's location within the vehicle. The method further includes maintaining, by the mobile device operating the mobile application, communication with a device coupled to the vehicle adjacent a steering wheel via an ultrawideband signal to enable real-time distance measurement between the device and the mobile device. The method further includes determining, by the mobile device operating the mobile application, that the velocity of the vehicle is above the threshold speed and that a distance between the mobile device and the device is below a threshold distance. The method further includes placing, by the mobile device operating the mobile application, the mobile device in a blocked mode in response to determining that the velocity of the vehicle is above the threshold speed and that the distance between the mobile device and the device is below the threshold distance.

In yet another embodiment, a non-transitory computer-readable medium storing instructions that, when executed by a processor of a mobile device, cause the processor to perform operations is provided. In this embodiment, the instructions cause the processor to determine a speed of a vehicle while traveling. The instructions cause the processor to communicate with a device coupled to the vehicle adjacent a steering wheel via an ultrawideband signal to determine a distance between the device and the mobile device. The instructions cause the processor to determine that the speed of the vehicle is at or above a threshold speed and that the distance between the mobile device and the device is at or below a threshold distance. The instructions cause the processor to place the mobile device in a blocked mode in response to the speed of the vehicle being at or above the threshold speed and the distance between the mobile device and the device being at or below the threshold distance.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a top diagrammatic view of a vehicle with a system for disabling screen engagement while driving, in accordance with an embodiment;

FIG. 2 is a side diagrammatic view of a vehicle with the system for disabling screen engagement while driving, in accordance with an embodiment;

FIG. 3 is a front view of a mobile device displaying a safe mode notification within the system, in accordance with an embodiment; and

FIG. 4 is a front view of a mobile device displaying a preferences screen within the system, in accordance with an embodiment.

### DETAILED DESCRIPTION OF EMBODIMENTS OF THE INVENTION

As discussed above, embodiments of the present invention relate to a system that senses movement of a vehicle while a mobile device is within proximity of the driver's location within the vehicle and disabling screen engagement on the mobile device. Disabling screen engagement may include disabling keyboard entry for tasks like messaging and placing or receiving phone calls, disabling screen display of text messages, or operating an app and so forth. Embodiments may include the ability of enabling hands free features in messaging apps, phone apps and the like or substitute hands-free applications.

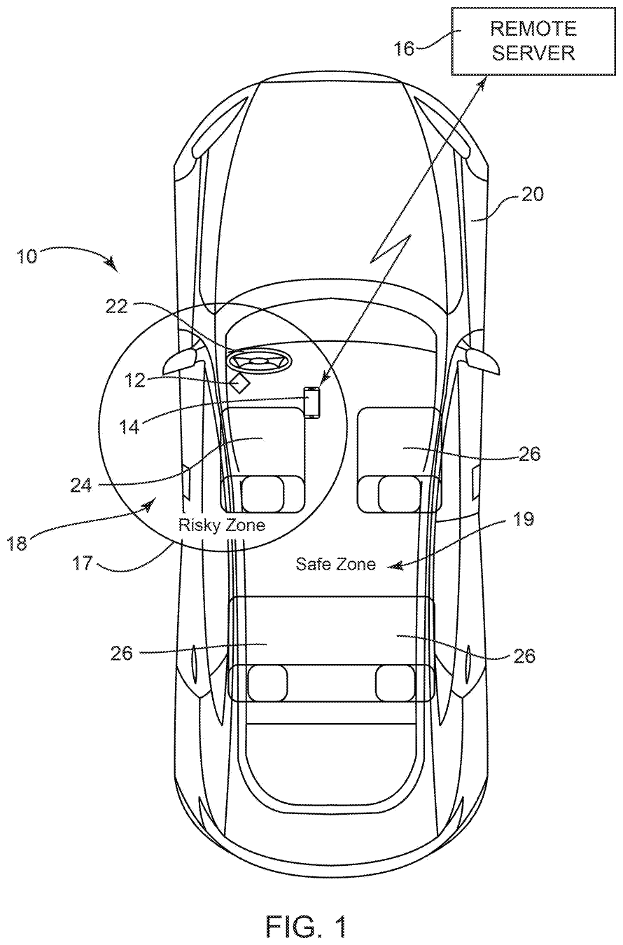

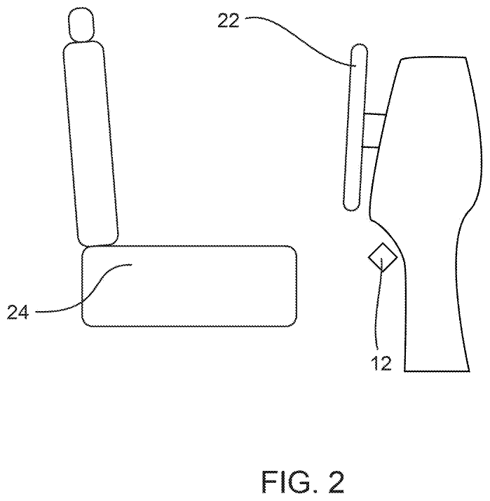

Referring to FIGS. 1 and 2, a vehicle 20 with a system 10 for disabling screen engagement while driving is shown. The system 10 may include a device 12 coupled to the vehicle 20 adjacent a steering wheel 22, a mobile device 14 running a mobile application, and a remote server 16 containing a central database. The device 12 may be installed in the vehicle 20 and may include one or more sensors, one or more radios, and one or more CPUs, wherein the CPUs include computer memory for storage of data and device-specific computer programs. The mobile device 14 may be a phone, cell phone, tablet, laptop, or similar device owned and operated by an end-user. The mobile device 14 may include an application operating on the mobile device 14, wherein the application provides programming operated by the mobile device 14 to function within the system 10. The remote server 16 may be a remote computer system that contains a central database for receiving and storing information sent from the application installed on the mobile device 14 and/or the device 12, one or both of which may periodically send usage data to the remote server 16 for storage in the central database.

The vehicle 20 includes a driver's seat 24 positioned behind the steering wheel 22 and one or more passenger seats 26 located in a front passenger area and a rear seating area of the vehicle 20. A distance threshold 17 is depicted as a boundary extending from the device 12, defining a risky zone 18 and a safe zone 19 within the vehicle 20. The area within the distance threshold 17 defines the risky zone 18, which includes the driver's seat 24 and the steering wheel 22 area. The safe zone 19 encompasses an area outside the distance threshold 17, which includes the passenger seats 26. When the vehicle 20 is traveling at or above a threshold speed, any mobile device 14 located within the risky zone 18 may be placed into a blocked mode by the mobile application operating on the mobile device 14. Mobile devices located in the safe zone 19, such as mobile devices held by passengers in the passenger seats 26, may retain full functionality and may not be subject to blocked mode restrictions.

The device 12 may communicate with the mobile device 14 through an ultrawideband signal to determine a distance between the device 12 and the mobile device 14. In some embodiments, the device 12 may also communicate with the mobile device 14 via Bluetooth or Bluetooth Low Energy. The ultrawideband signal may enable real-time distance measurement between the device 12 and the mobile device 14, allowing the system 10 to distinguish between a mobile device 14 in the risky zone 18 near the driver's seat 24 and mobile devices in the safe zone 19 near the passenger seats 26. In this way, the mobile device 14 running the application and the device 12 may operate to frequently calculate the distance between the mobile device 14 and the steering wheel 22.

Referring to FIG. 2, depicted is a possible spatial relationship between the device 12, the steering wheel 22, and the driver's seat 24. The device 12 is shown coupled to the vehicle 20 adjacent the steering wheel 22, positioned to enable communication with mobile devices within the vehicle 20. The steering wheel 22 is shown in profile view extending from a dashboard area of the vehicle 20. The driver's seat 24 is positioned behind and below the steering wheel 22, representing a location where a driver would be seated during vehicle operation. This arrangement enables the system 10 to determine the proximity of a mobile device 14 to the driver's location within the vehicle 20, which may be used in conjunction with vehicle speed determination to activate the blocking mode functionality of the system 10.

With continued reference to FIG. 1, the mobile device 14 operating the mobile application may determine a speed of the vehicle 20 while traveling. The mobile device 14 may calculate the speed of the vehicle 20 through an accelerometer of the mobile device 14. In some embodiments, the mobile device 14 may calculate the speed of the vehicle 20 through a global positioning system (GPS) of the mobile device 14. In some embodiments, the mobile device 14 may determine the speed of the vehicle 20 based on data received from the device 12.

The device 12 may also be configured to determine the speed of the vehicle 20. The device 12 may calculate the speed of the vehicle 20 through an accelerometer of the device 12. In some embodiments, the device 12 may calculate the speed of the vehicle 20 through GPS data. In some embodiments, the device 12 may obtain speed information from an on-board diagnostics system (OBD-II) of the vehicle 20. The device 12 may send and receive data with the OBD-II of the vehicle 20. The device 12 may use the OBD-II to communicate with the remote server 16.

The mobile application operating on the mobile device 14 may include two thresholds for operation of the system 10. For example and without limitation, a first is a threshold speed representing a maximum vehicle velocity and a second is a threshold distance representing a minimum distance between the mobile device 14 and the device 12. The threshold speed may be set at a value such as 10 miles per hour or 20 miles per hour. The threshold distance may be set at a predetermined value such as, without limitation, 40 inches. When the mobile application on the mobile device 14 determines that both thresholds are met or exceeded, the mobile device 14 may be placed in a blocked mode. The mobile application may determine that both thresholds are met or exceeded when the vehicle 20 is traveling at a speed at or above the threshold speed and when the distance between the device 12 and the mobile device 14 is at or below the threshold distance. In response to both threshold conditions being satisfied, the mobile application running on the mobile device 14 may block unsafe uses of the mobile device 14 by placing the mobile device 14 in the blocked mode.

The mobile device 14 operating the mobile application may activate Bluetooth (BT) or Bluetooth Low Energy (BLE) systems and radios of the mobile device 14 to initiate a communication session with the device 12. The mobile application may also activate ultrawideband (UWB) systems and radios of the mobile device 14. The mobile application may initiate communication with the device 12 using BT, BLE, or UWB. Once a communication session is initiated, the ultrawideband signal may be used for determining the distance between the device 12 and the mobile device 14. The mobile application may maintain communication with the device 12 via Bluetooth in addition to the ultrawideband signal. In some embodiments, Bluetooth may be used to handshake the device 12 with the mobile device 14, and UWB may then be used for location determination and ranging between the device 12 and the mobile device 14.

The device 12 may also initiate communication sessions with nearby mobile devices running the mobile application. When the vehicle 20 is in operation, the device 12 may activate and may be programmed to communicate with nearby mobile application enabled phones. The device 12 may communicate with mobile application enabled phones using BT, BLE, or UWB to initiate a communication session. Once the communication session is initiated, sensors of the device 12 and the mobile device 14 may use UWB to determine the distance between the mobile device 14 and the driver's location within the vehicle 20.

The device 12 may comprise one or more central processing units (CPUs), computer memory, one or more radios, and one or more computer programs stored in the computer memory. The device 12 may further include sensors configured to calculate position, changes in position, and rates of change in position. The rates of change in position may correspond to speed measurements of the vehicle 20. The one or more radios of the device 12 may include ultrawideband radios, Bluetooth radios, and Bluetooth Low Energy radios to enable communication with the mobile device 14 and other mobile devices within the vehicle 20.

The device 12 may be battery powered. In some embodiments, the device 12 may be integrated with an existing electric power system of the vehicle 20. Integration with the electric power system of the vehicle 20 may allow the device 12 to receive power from the vehicle 20 during vehicle operation.

The device 12 may be integrated with an on-board diagnostics system (OBD-II) of the vehicle 20. The device 12 may send and receive data with the OBD-II of the vehicle 20. In some embodiments, the device 12 may obtain speed information from the OBD-II of the vehicle 20. The device 12 may use the OBD-II to communicate with the remote server 16. Communication with the remote server 16 via the OBD-II may enable the device 12 to transmit usage data and receive configuration updates through the on-board diagnostics system of the vehicle 20.

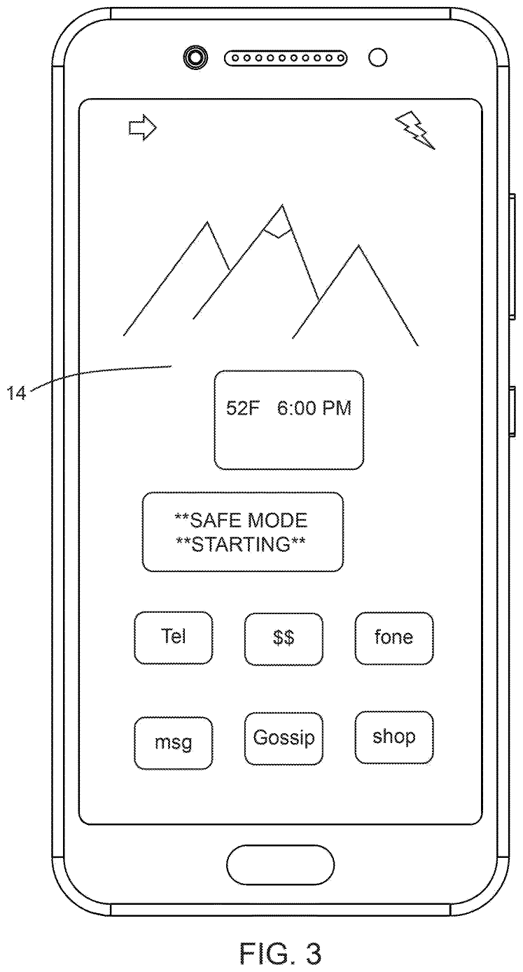

Referring to FIG. 3, a front view of the mobile device 14 displaying a screen interface showing the mobile device 14 entering a safe mode state is depicted. The screen of the mobile device 14 may display a notification box displays text indicating “SAFE MODE STARTING,” which indicates that the mobile device 14 is transitioning into the blocked mode in response to the threshold conditions being met. The threshold conditions may include the speed of the vehicle 20 being at or above the threshold speed and the distance between the mobile device 14 and the device 12 being at or below the threshold distance.

A lower portion of the screen on the mobile device 14 shows a grid of application icons representing various applications installed on the mobile device 14. When the safe mode is engaged, the applications represented by the application icons may be subject to restricted functionality. The restricted functionality may include disabling keyboard entry for messaging, disabling placing or receiving phone calls, disabling screen display of text messages, or disabling operation of an application.

In some embodiments, the blocked mode may be implemented by automatically switching the mobile device 14 to a driving mode state native to an operating system of the mobile device 14. For example, the mobile application operating on the mobile device 14 may automatically switch the mobile device 14 to Apple Driving Focus when the mobile device 14 operates using an iOS operating system. In another example, the mobile application may automatically switch the mobile device 14 to Google Assistant Driving Mode when the mobile device 14 operates using an Android operating system. In some embodiments, the mobile application may block keyboard entry in commonly used applications and may provide hands-free substitutes for the commonly used applications or may initiate hands-free features of the commonly used applications. The mobile application may enable hands-free features in messaging applications or phone applications, or may activate substitute hands-free applications to allow the user to continue certain communications while the mobile device 14 is in the blocked mode.

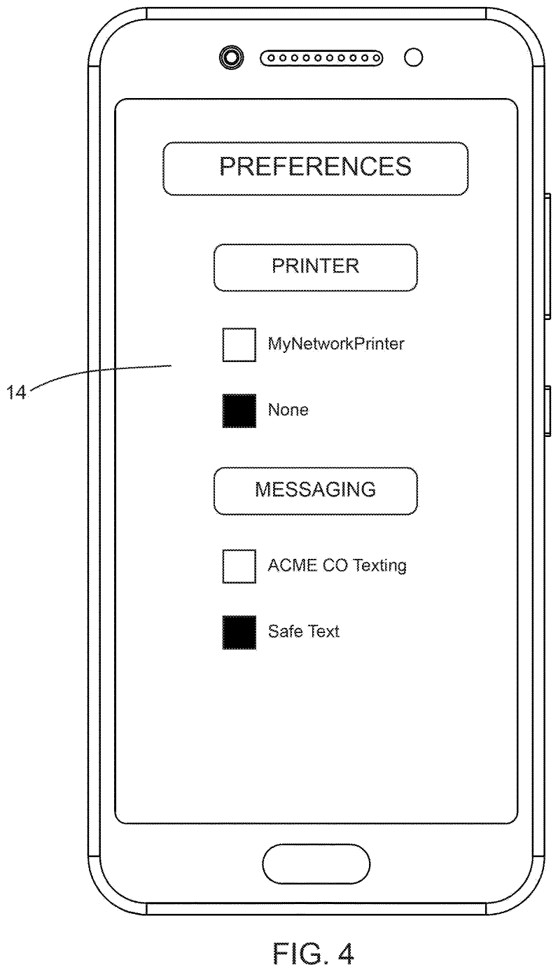

In some embodiments, the mobile application may provide a Safe Text interface on the mobile device 14 when the mobile device 14 is operating in the blocked mode. The Safe Text interface may display text messages from one or more contacts with keyboard entry disabled. The Safe Text interface may include a visual indication that keyboard entry is disabled, such as a notification stating “KEYBOARD OFF” displayed adjacent to a representation of a keyboard. the Safe Texrt interface may be a selection that a user may initiate in the mobile application preferences as shown in FIG. 4.

In some embodiments, the mobile application may track when the mobile device 14 is plugged into a vehicle infotainment system that activates Apple CarPlay or Google driving mode. The mobile application may detect the connection between the mobile device 14 and the vehicle infotainment system and may monitor the engagement status of the third-party safe driving application during vehicle operation.

When the mobile device 14 is within the threshold distance from the device 12, the speed of the vehicle 20 is at or above the threshold speed, and a third-party safe driving application is engaged on the mobile device 14, the mobile application may report usage to the remote server 16 as if the mobile device 14 were in the blocked mode. In this configuration, the mobile application recognizes that the third-party safe driving application provides safe driving functionality and credits the usage accordingly. The mobile application may transmit usage data to the remote server 16 indicating that the mobile device 14 was operating in a safe driving state during the period when the threshold conditions were met and the third-party safe driving application was engaged.

The usage data reported to the remote server 16 may include miles driven above the threshold speed with the mobile application enabled on the mobile device 14 while the mobile application or a third-party safe driving application is in use. The remote server 16 may store the usage data in a central database, wherein the usage data may be used to track compliance with safe driving practices regardless of whether the mobile device 14 was operating in the blocked mode of the mobile application or in a third-party safe driving application.

With continued reference to FIG. 1, the mobile application operating on the mobile device 14 may frequently check both the speed of the vehicle 20 and the distance between the mobile device 14 and the device 12. The mobile application may perform threshold monitoring at regular intervals during vehicle operation to determine whether the threshold conditions for the blocked mode remain satisfied. The threshold conditions may include the speed of the vehicle 20 being at or above the threshold speed and the distance between the mobile device 14 and the device 12 being at or below the threshold distance.

When the mobile application operating on the mobile device 14 determines that the blocked mode is not needed for safe operation, the mobile application may automatically cease the blocked mode. The mobile application may determine that the blocked mode is not needed for safe operation when the speed of the vehicle 20 falls below the threshold speed or when the distance between the mobile device 14 and the device 12 exceeds the threshold distance. In some embodiments, the mobile application may terminate the blocked mode when either threshold condition is no longer satisfied. In some embodiments, the mobile application may terminate the blocked mode only when both threshold conditions are no longer satisfied.

The device 12 may compute which mobile devices are in risky positions within the vehicle 20. The device 12 may use ultrawideband signals to detect the distance to each mobile device running the mobile application within the vehicle 20. The device 12 may report range measurements to one or more central processing units of the device 12. The one or more central processing units of the device 12 may analyze the range measurements to identify mobile devices located within the risky zone 18. The device 12 may link to mobile devices identified as being in risky positions via ultrawideband or Bluetooth. The device 12 may instruct mobile devices in risky positions to restrict keyboard entry or to enter the blocked mode. In at least this way, the device 12 may coordinate with multiple mobile devices within the vehicle 20 to place mobile devices in the risky zone 18 into the blocked mode while allowing mobile devices in the safe zone 19 to retain full functionality.

The mobile application operating on the mobile device 14 may be available for download and installation on the mobile device 14 via common application distribution portals. The mobile device 14 may be a phone, cell phone, tablet, laptop, or similar device owned and operated by an end-user.

Users may establish an account with the system 10 by performing a registration process through the mobile application. The registration process may require the user to submit personal information through the mobile application of the mobile device 14. The personal information may include identification information and related information as needed to register the user's use of the mobile application. The personal information may include information needed to register the user's use of the mobile application with an insurance provider of the user. In some embodiments, the registration process may be initiated via a web portal accessing the remote server 16 and completed via the mobile application for each individual mobile device 14 associated with the user's account. In some embodiments, multiple users may register multiple mobile devices 14 under associated accounts through the web portal and the mobile application.

The user may elect to enable or disable the mobile application on the mobile device 14. When the mobile application is enabled, the mobile application may initiate communication between the mobile device 14 and the device 12 to perform the functions of the system 10. When the mobile application is disabled, the mobile device 14 may operate without the blocking mode functionality provided by the system 10.

The mobile device 14 operating the mobile application or the device 12 may periodically send usage data to the remote server 16. The remote server 16 may comprise a central database for receiving and storing the usage data transmitted from the mobile device 14 and the device 12. The remote server 16 may include one or more computers comprising central processing units and computer memory. The central database stored on the remote server 16 may be accessible via the internet to end-users of the system 10.

The usage data transmitted to the remote server 16 may comprise miles driven above the threshold speed with the mobile application enabled on the mobile device 14 while the mobile application or a third-party safe driving application is in use. The usage data may further comprise miles driven above the threshold speed without the mobile application enabled on the mobile device 14. In some embodiments, the usage data may be associated with user information stored in the central database when the user registered to use the system 10.

The movement data reported by the device 12 may include mileage accumulated while one or more mobile devices are operating in the blocked mode within the vehicle 20. The device 12 may also report mileage accumulated while no mobile devices are operating in the blocked mode within the vehicle 20. In some embodiments, the device 12 may track and report mileage driven with mobile devices in restricted modes and mileage driven without mobile devices in restricted modes.

The mobile application may also report usage data when the mobile device 14 is using a third-party safe driving application while the threshold conditions are met. The threshold conditions may include the speed of the vehicle 20 being at or above the threshold speed and the distance between the mobile device 14 and the device 12 being at or below the threshold distance. In this configuration, the mobile application may credit usage to the central database when the mobile device 14 is operating in either the blocked mode of the mobile application or in a third-party safe driving application that provides safe driving functionality.

In some embodiments, the mobile application may report to the device 12 information regarding other applications used on the mobile device 14 while the vehicle 20 is in motion. The device 12 or the mobile application may transmit reports regarding the usage of other applications to the remote server 16 for storage in the central database.

Access to the central database stored on the remote server 16 may be limited to authorized users based on user roles. For example, a customer may access data regarding individual vehicle use associated with the customer's account, including usage data for vehicles equipped with the device 12 and mobile devices 14 registered to the customer's account. The customer may access the central database via the internet through a web portal or through the mobile application operating on the mobile device 14.

In some embodiments, an insurance company may access individual data of registered customers of the insurance company. The insurance company may access usage data for customers who have registered the mobile application with the insurance company during the registration process. The individual data accessible to the insurance company may include miles driven above the threshold speed with the mobile application enabled on the mobile device 14 while the mobile application or a third-party safe driving application is in use, and miles driven above the threshold speed without the mobile application enabled on the mobile device 14.

In some embodiments, an insurance company may be licensed to access group data comprising data of all customers who use the mobile application on mobile devices 14 and devices 12 coupled to vehicles 20. The group data may include aggregated usage data across multiple customers and multiple vehicles equipped with the device 12. The licensed access to group data may enable the insurance company to analyze driving behavior patterns across a population of users of the system 10.

In some embodiments, licensed users may obtain reports on the usage of other applications on mobile devices 14 while vehicles 20 are in motion. The reports may include information regarding applications used on the mobile device 14 during vehicle operation, such as messaging applications or social media applications. The mobile application may transmit reports regarding the usage of other applications to the remote server 16 for storage in the central database, and licensed users may access the reports through the central database.

With continued reference to FIG. 1, the system 10 may support a system of incentives provided by automotive insurance companies. An insurance company may provide a discount on an insurance premium to a customer based on usage data indicating use of the mobile application on the mobile device 14 in a vehicle 20 equipped with the device 12. The measurable consistency may be determined by calculating a percentage of miles driven above the threshold speed while the mobile application or a third-party safe driving application is enabled. For example, an insurance company may offer a discount to a customer for driving 80% of miles above 20 miles per hour with the mobile application enabled. The insurance company may access the usage data stored in the central database to evaluate compliance across multiple vehicles and mobile devices associated with a customer account, and may adjust premium rates based on changes in the usage data over time.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A system for disabling screen engagement on a mobile device, the system comprising:
a device coupled to a vehicle adjacent a steering wheel of the vehicle; and
a mobile device running a mobile application, the mobile device coupled to the device, wherein:
the mobile device operating the mobile application is programmed to determine a speed of the vehicle while traveling;
the device communicates with the mobile device through an ultrawideband signal and is programmed to determine a distance between the device and the mobile device;
the mobile device operating the mobile application is programmed to determine that the speed of the vehicle is at or above a threshold speed and that the distance between the mobile device and the device is at or below a threshold distance; and
the mobile device operating the mobile application is programmed to place the mobile device in a blocked mode in response to the speed of the vehicle being at or above a threshold speed and that the distance between the mobile device and the device being at or below a threshold distance.

2. The system of claim 1, wherein the mobile device operating the mobile application is programmed to determine the speed of the vehicle through at least one of an accelerometer of the mobile device, a global positioning system of the mobile device, or data received from the device.

3. The system of claim 1, wherein the device is programmed to determine the speed of the vehicle through at least one of an accelerometer of the device, a global positioning system of the device, or data obtained from an on-board diagnostics system of the vehicle.

4. The system of claim 1, wherein the mobile device operating the mobile application is programmed to activate a Bluetooth or Bluetooth Low Energy system of the mobile device to initiate a communication session with the device, and wherein the ultrawideband signal is used for determining the distance between the device and the mobile device.

5. The system of claim 1, wherein the mobile device operating the mobile application is programmed to maintain communication with the device via Bluetooth in addition to the ultrawideband signal.

6. The system of claim 1, wherein placing the mobile device in the blocked mode comprises automatically switching the mobile device to a driving mode state native to an operating system of the mobile device.

7. The system of claim 1, wherein placing the mobile device in the blocked mode comprises blocking keyboard entry in one or more applications operating on the mobile device and providing hands-free substitutes for the one or more applications or initiating hands-free features of the one or more applications.

8. The system of claim 1, wherein placing the mobile device in the blocked mode comprises at least one of disabling keyboard entry for messaging, disabling placing or receiving phone calls, disabling screen display of text messages, or disabling operation of an application.

9. The system of claim 1, wherein the mobile device operating the mobile application is programmed to enable hands-free features in at least one of messaging applications or phone applications, or to activate substitute hands-free applications.

10. The system of claim 1, wherein the mobile device operating the mobile application is programmed to track engagement of a third-party safe driving application on the mobile device, and wherein when the mobile device is within the threshold distance from the device, the speed of the vehicle is at or above the threshold speed, and the third-party safe driving application is engaged, the mobile device operating the mobile application is programmed to report usage to a remote server as if the mobile device were in the blocked mode.

11. The system of claim 1, wherein the mobile device operating the mobile application is programmed to frequently check the speed of the vehicle and the distance between the mobile device and the device, and to automatically cease the blocked mode when the mobile device operating the mobile application determines that the blocked mode is not needed for safe operation.

12. A method for disabling screen engagement on a mobile device, the method comprising:
sensing, by a mobile device operating a mobile application, movement of a vehicle at a velocity above a threshold speed;
determining, by the mobile device operating the mobile application, a proximity of the mobile device to a driver's location within the vehicle;
maintaining, by the mobile device operating the mobile application, communication with a device coupled to the vehicle adjacent a steering wheel via an ultrawideband signal to enable real-time distance measurement between the device and the mobile device;
determining, by the mobile device operating the mobile application, that the velocity of the vehicle is above the threshold speed and that a distance between the mobile device and the device is below a threshold distance; and
placing, by the mobile device operating the mobile application, the mobile device in a blocked mode in response to determining that the velocity of the vehicle is above the threshold speed and that the distance between the mobile device and the device is below the threshold distance.

13. The method of claim 12, further comprising:
periodically sending, by at least one of the mobile device operating the mobile application or the device, usage data to a remote server comprising a central database.

14. The method of claim 13, wherein the usage data comprises miles driven above the threshold speed with the mobile application enabled on the mobile device while the mobile application or a third-party safe driving application is in use, and miles driven above the threshold speed without the mobile application enabled on the mobile device.

15. The method of claim 13, further comprising:
limiting access to the central database to authorized users, wherein authorization is based on a role of a user, and wherein a customer accesses data regarding individual vehicle use and an insurance company accesses individual data of registered customers of the insurance company.

16. The method of claim 13, further comprising:
providing, by an insurance company, a discount on an insurance premium to a customer in response to usage data indicating use of the mobile application on the mobile device in a vehicle equipped with the device.

17. The method of claim 13, further comprising:
offering, by an insurance company, a policy discount to a customer who uses the mobile application on the mobile device and the device with a measurable consistency based on the usage data stored in the central database.

18. A non-transitory computer-readable medium storing instructions that, when executed by a processor of a mobile device, cause the processor to:
determine a speed of a vehicle while traveling;
communicate with a device coupled to the vehicle adjacent a steering wheel via an ultrawideband signal to determine a distance between the device and the mobile device;
determine that the speed of the vehicle is at or above a threshold speed and that the distance between the mobile device and the device is at or below a threshold distance; and
place the mobile device in a blocked mode in response to the speed of the vehicle being at or above the threshold speed and the distance between the mobile device and the device being at or below the threshold distance.

19. The non-transitory computer-readable medium of claim 18, wherein the device comprises sensors to calculate position, changes in position, and rates of change in position, and wherein the device is at least one of battery powered or integrated with an electric power system of the vehicle.

20. The non-transitory computer-readable medium of claim 18, wherein the device is integrated with an on-board diagnostics system of the vehicle, and wherein the device is configured to send and receive data with the on-board diagnostics system and to communicate with a remote server via the on-board diagnostics system.
